(19) United States
(12) Patent Application Publication
(10) Pub. No.: US 2012/0233859 A1
(43) Pub. Date: Sep. 20, 2012

(54) METHOD FOR PRODUCING A METAL REINFORCEMENT FOR A TURBINE ENGINE BLADE

(75) Inventors: Bernard José Michel Cattiez, Evry (FR); Thierry Jean Emile Flesch, Pringy (FR); Jérôme Guinois, Corbeil Essonnes (FR); Stéphane André Leveque, Marcoussis (FR); Philippe Marolle, Wissous (FR)

(73) Assignee: SNECMA, Paris (FR)

(21) Appl. No.: 13/512,451

(22) PCT Filed: Nov. 30, 2010
(86) PCT No.: PCT/EP2010/068578

§ 371 Date: May 29, 2012

(30) Foreign Application Priority Data
Nov. 30, 2009 (FR) 0958528

(51) Int. Cl. B23P 15/04; B23K 9/04

(52) U.S. Cl. 29/889.7; 219/76.14

(57) ABSTRACT

A method for making a metal reinforcement for the leading edge or trailing edge of a turbine engine blade, including: positioning a preform using an equipment positioning the preform in a position such that the preform, at one end thereof, has an area which is capable of receiving a filler metal; and, after the positioning, constructing a base for the metal reinforcement by hard-surfacing with filler metal in the area, in the form of metal beads.

The present invention relates to a method for producing a metal reinforcement for a composite or metal turbine engine blade.

More specifically, the invention relates to a method for producing a metal reinforcement for the leading edge of a turbine engine blade.

The field of the invention is that of turbine engines and more specifically that of turbine engine fan blades, in composite or metallic material, wherein the leading edge comprises a metal structural reinforcement.

However, the invention is also applicable to making a metal reinforcement intended to reinforce a trailing edge of a turbine engine blade.

It is noted that the leading edge corresponds to the anterior part of an aerodynamic profile that faces the flow of air and divides the air flow into a lower surface air flow and an upper surface air flow. The trailing edge corresponds to the posterior part of an aerodynamic profile where the lower surface and upper surface flows meet.

Equipping fan blades of a turbine engine, made in composite materials, with a metal structural reinforcement extending over the entire height of the blade and beyond their leading edge as mentioned in document EP1908919 is known. Such a reinforcement enables the composite blading to be protected during an impact by a foreign body on the fan, such as, for example, a bird, hail or else stones.

In particular, the metal structural reinforcement protects the leading edge of the composite blade by preventing delamination and fiber breakage risks or else damage by fiber/matrix debonding.

Conventionally, a turbine engine blade comprises an aerodynamic surface extending, along a first direction, between a leading edge and a trailing edge and, along a second direction substantially perpendicular to the first direction, between a foot and a top of the blade. The metal structural reinforcement follows the form of the leading edge of the aerodynamic surface of the blade and extends along the first direction beyond the leading edge of the aerodynamic surface of the blade to follow the profile of the lower surface and the upper surface of the blade and along the second direction between the foot and the top of the blade.

In a known manner, the metal structural reinforcement is a metal piece made entirely by milling from a block of material.

Another example of embodiment of such a metal structural reinforcement is notably described in document FR2319008.

However, the metal reinforcement for the leading edge of the blade is a complex piece to make, necessitating many refinishing operations and complex equipment involving significant production costs.

In this context, the invention aims to resolve the problems mentioned above by proposing a method of producing a metal reinforcement for the leading edge or trailing edge of a turbine engine blade enabling the costs of producing such a piece to be significantly reduced and the manufacturing process to be simplified.

For that purpose, the invention proposes a method of producing a metal reinforcement for the leading edge or trailing edge of a turbine engine blade, comprising successively:
a step of positioning a preform by means of equipment positioning said preform in a position such that said preform presents at one end an area capable of receiving the filler metal;
a step of constructing a base for said metal reinforcement by hard-surfacing with filler metal in said area, in the form of metal beads.

Thanks to the invention, the metal structural reinforcement is made simply and rapidly from a preform and a method to reconstruct material by MIG (Metal Inert Gas) welding, constructing the base of the reinforcement from the end of the preform placed in maintaining and conforming equipment. Preferentially, the MIG method used is an improvement known as CMT (Cold Metal Transfer) that is described in application FR0802986. This particular method enables significant volumes of material to be deposited by minimizing deformation of sheets.

This production method therefore eliminates the complex production of the reinforcement by milling in the mass from flat parts requiring a large volume of stock material and, consequently, significant costs to supply the raw material.

The method according to the invention also enables the costs to produce such a piece to be substantially reduced.

Advantageously, the preform is formed by a first metal sheet and by a second metal sheet positioned in the equipment such that they present at their end a joint that is capable of receiving the welding material.

The method to produce a metal reinforcement for a turbine engine blade according to the invention may also present one or more of the characteristics below, considered individually or according to all technically possible combinations:
said step of constructing by hard-surfacing with filler metal is carried out by means of an MIG welding apparatus comprising a pulsed current generator and presenting a pulsed deposition wire flow;
said preform comprises a first metal sheet and a second metal sheet positioned, by means of said equipment, in a non-parallel position such that they present at their end an area capable of receiving said filler metal, said step to construct said base of said reinforcement uniting said metal sheets in position;
said preform is formed by a hot preformed metal sheet such that said preform comprises sides and, at one end, an area capable of receiving said filler metal;
said construction step is followed by a step of machining said hard-surfaced material in said welding area so as to approximate the final profile of said base;
the method comprises a thermal treatment step to relieve stresses;
the method comprises a hot conformation step;
the method comprises a step to finish said metal reinforcement consisting of the refinishing of said hard-surfaced material so as to refine the final profile of said base and the leading edge or trailing edge of said metal reinforcement and/or the refinishing of metal sheets so as to form the sides of said metal reinforcement;
the method comprises a step of cutting said first metal sheet and said second metal sheet by laser cutting;
the method comprises an operation consisting of increasing the roughness of the inner faces of said sides;
the method comprises a step of forming said metal sheets before said positioning step in said equipment;
during said positioning step, said metal sheets are formed in said equipment and are kept joined;
during said positioning step, said metal sheets are formed and are kept spaced apart by a dagger positioned between said metal sheets, the outer profile of said dagger conforming the lower surface and upper surface profile of said metal sheets;
the method comprises a step of evacuating the heat from said metal sheets in position in said equipment via said equipment.

Other characteristics and advantages of the invention will more clearly emerge from the description given below, for indicative and in no way limiting purposes, with reference to the attached figures, among which:

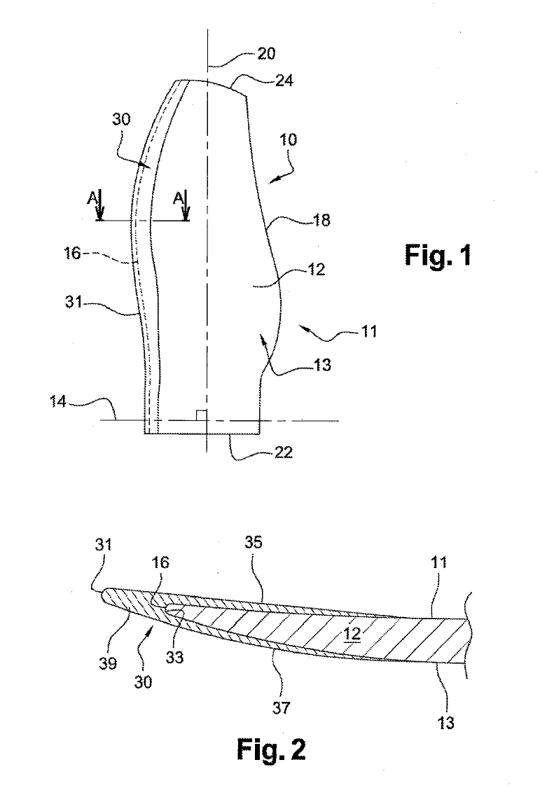

FIG. 1 is a lateral view of a blade comprising a metal structural reinforcement of the leading edge obtained by means of the production method according to the invention;

FIG. 2 is a partial cross sectional view of FIG. 1 along cutting plane AA;

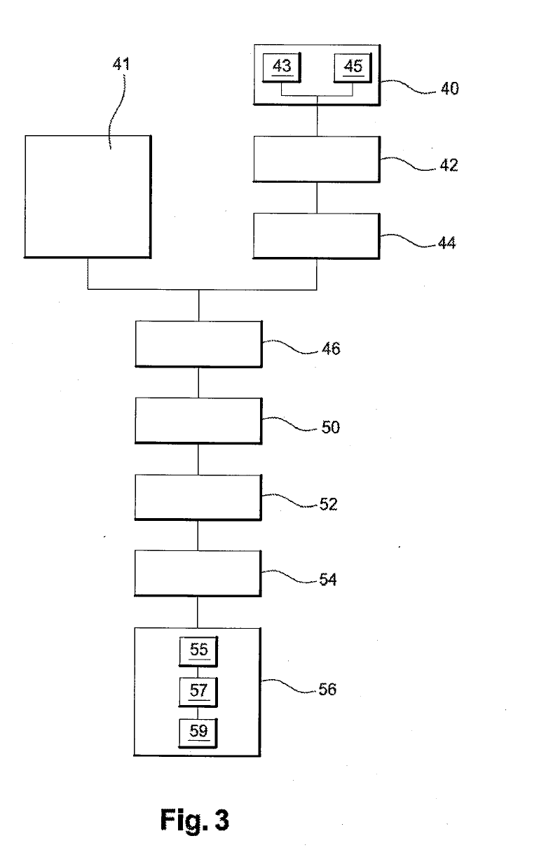

FIG. 3 is a block diagram presenting the main steps of producing a metal structural reinforcement for the leading edge of a turbine engine blade according to the invention;

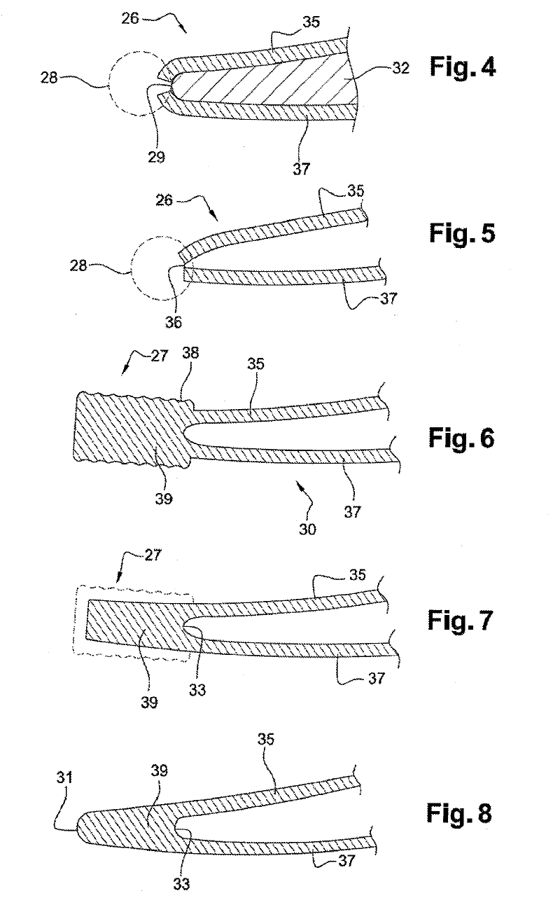

FIG. 4 is a partial cross sectional view of the metal reinforcement for the leading edge of a turbine engine blade during a first embodiment of the third step of the method illustrated in FIG. 3;

FIG. 5 is a partial cross sectional view of the metal reinforcement for the leading edge of a turbine engine blade during a second embodiment of the third step of the method illustrated in FIG. 3;

FIG. 6 is a partial cross sectional view of the metal reinforcement for the leading edge of a turbine engine blade during the fourth step of the method illustrated in FIG. 3;

FIG. 7 is a partial cross sectional view of the metal reinforcement for the leading edge of a turbine engine blade during a fifth step of the method illustrated in FIG. 3;

FIG. 8 is a partial cross sectional view of the metal reinforcement for the leading edge of a turbine engine blade in its final state obtained by the method according to the invention illustrated in FIG. 3;

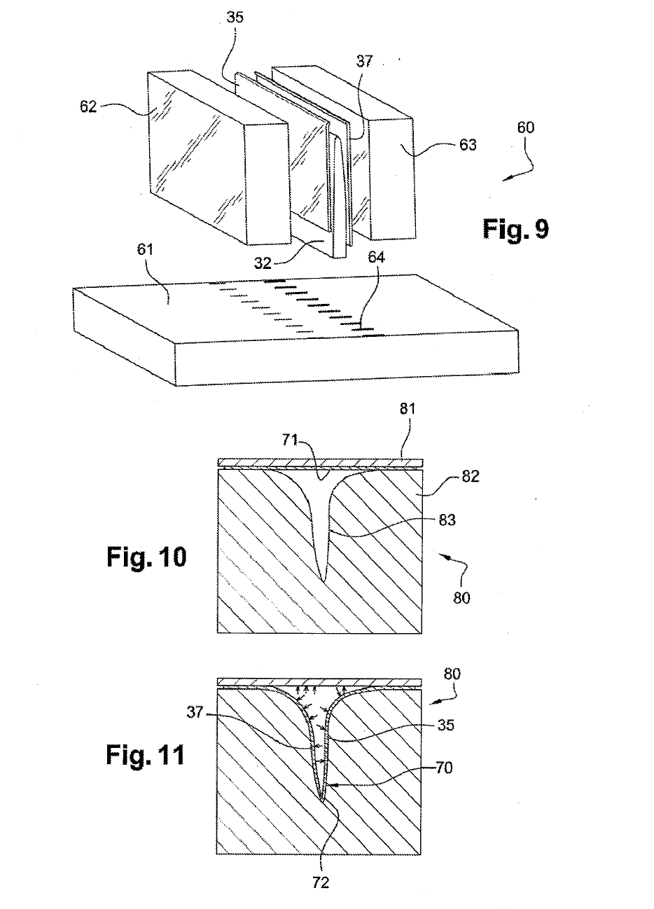

FIG. 9 illustrates a blow-up view of the specific maintaining equipment used for producing the metal reinforcement for the leading edge according to the method illustrated in FIG. 3;

FIG. 10 illustrates a view of the metal reinforcement for the leading edge of a turbine engine blade in its initial state during a second embodiment of a preform according to the method illustrated in FIG. 3;

FIG. 11 illustrates a view of the metal reinforcement for the leading edge of a turbine engine blade in its final state during a second embodiment of a preform according to the method illustrated in FIG. 3;

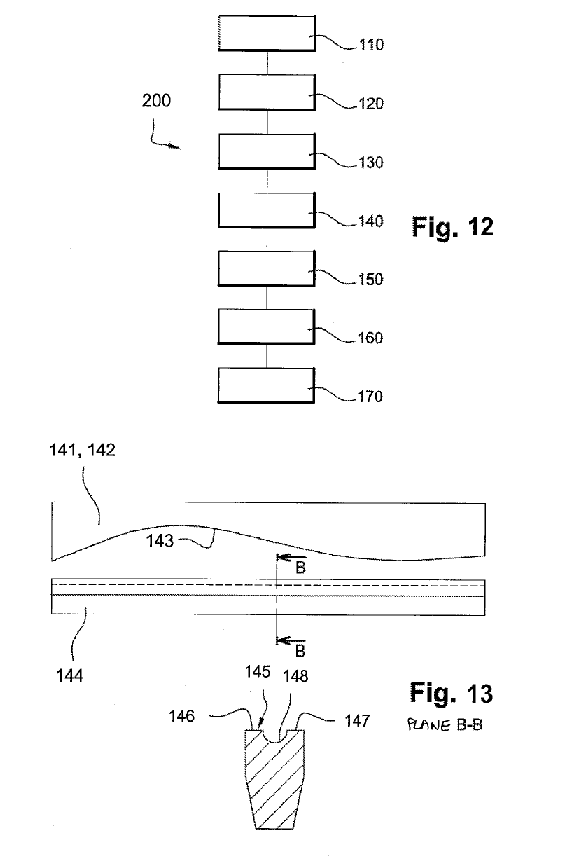

FIG. 12 is a block diagram presenting the main steps of producing a metal structural reinforcement for the leading edge of a turbine engine blade of a second method of producing a metal reinforcement;

FIG. 13 is a view of the metal reinforcement for the leading edge of a turbine engine blade during the first step of the second method illustrated in FIG. 12;

FIG. 14 is a view of the metal reinforcement for the leading edge of a turbine engine blade during the second step of the second method illustrated in FIG. 12;

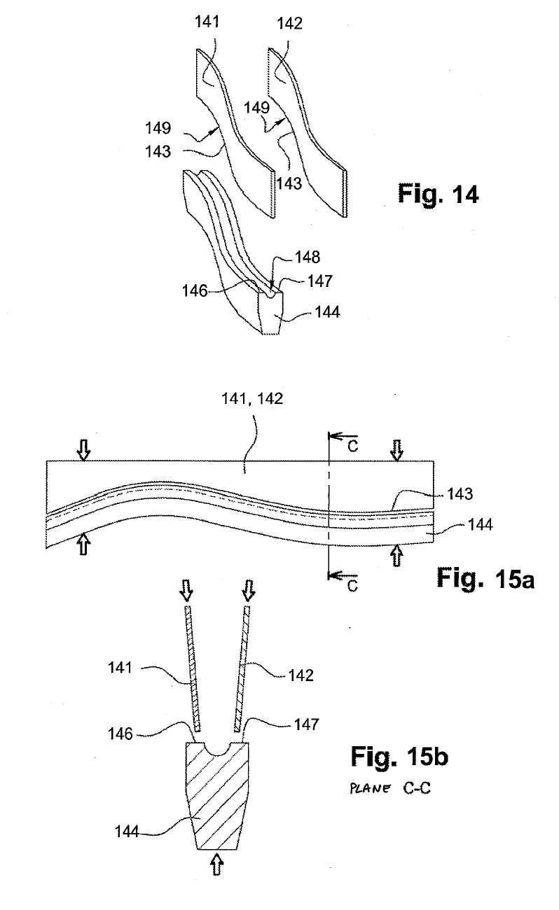

FIG. 15a is a side view of the metal reinforcement for the leading edge of a turbine engine blade during the third step of the second method illustrated in FIG. 12;

FIG. 15b is a cross sectional view of the metal reinforcement for the leading edge of a turbine engine blade illustrated in FIG. 15a along cutting plane C-C;

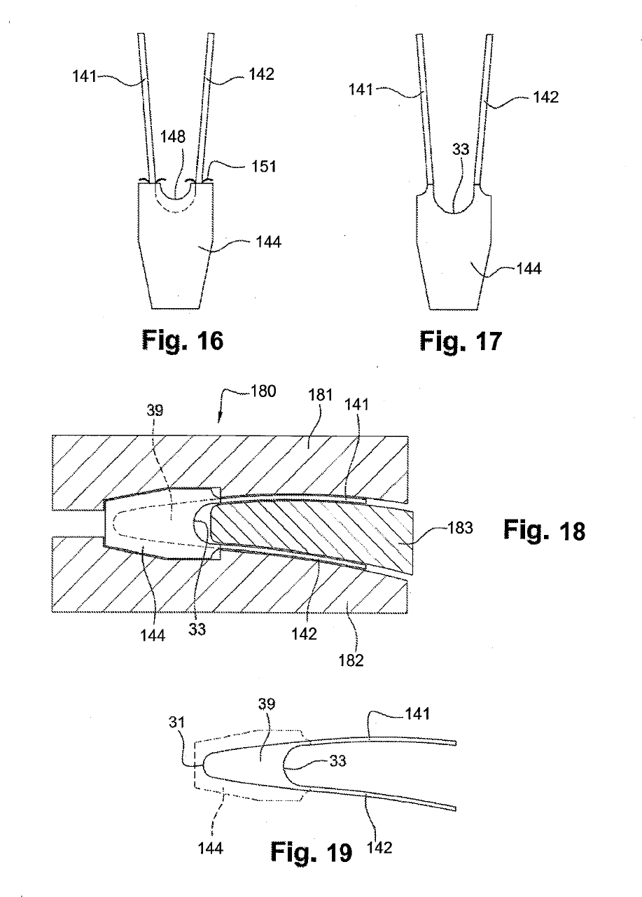

FIG. 16 is a front view of the metal reinforcement for the leading edge of a turbine engine blade during the fourth step of the second method illustrated in FIG. 12;

FIG. 17 is a front view of the metal reinforcement for the leading edge of a turbine engine blade during the fifth step of the second method illustrated in FIG. 12;

FIG. 18 is a view of the metal reinforcement for the leading edge of a turbine engine blade during the sixth step of the second method illustrated in FIG. 12;

FIG. 19 is a front view of the metal reinforcement for the leading edge of a turbine engine blade during the seventh step of the second method illustrated in FIG. 12;

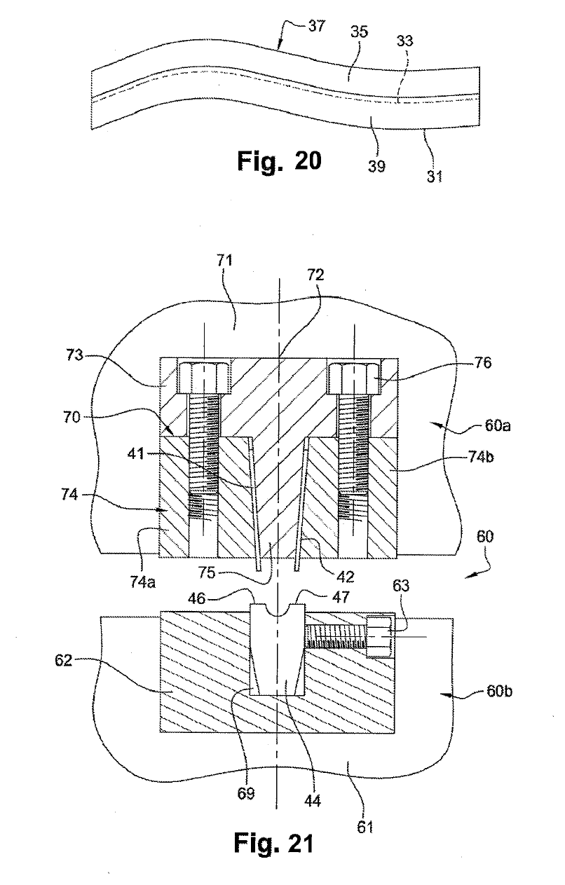

FIG. 20 is a side view of the metal reinforcement for the leading edge of a turbine engine blade in its final state obtained by the second method illustrated in FIG. 12;

FIG. 21 is a cross sectional view of the specific maintaining equipment used for making the metal reinforcement for the leading edge according to the second method illustrated in FIG. 12.

In all figures, common elements bear the same reference numbers, unless otherwise indicated.

FIG. 1 is a lateral view of a blade comprising a metal structural reinforcement for the leading edge obtained by means of the production method according to the invention.

The blade 10 illustrated is, for example, a mobile fan blade of a turbine engine (not represented).

Blade 10 comprises an aerodynamic surface 12 extending, along a first axial direction 14, between a leading edge 16 and a trailing edge 18 and, along a second radial direction 20 substantially perpendicular to the first direction 14, between a foot 22 and a top 24.

The aerodynamic surface 12 forms the upper face 13 and lower face 11 of blade 10, only the upper face 13 of blade 10 is represented in FIG. 1. The lower face 11 and upper face 13 form the lateral faces of blade 10 that connect the leading edge 16 to the trailing edge 18 of the blade 10.

In this embodiment, the blade 10 is a composite blade typically obtained by draping a woven composite material. By way of example, the composite material used may be composed of an assemblage of woven carbon fibers and a resin matrix, the assembly being formed by molding by means of an RTM (Resin Transfer Molding) type vacuum resin injection process.

Blade 10 comprises a metal structural reinforcement 30 glued at its leading edge 16 and that extends both along the first direction 14 beyond the leading edge 16 of the aerodynamic surface 12 of blade 10 and along the second direction 20 between the foot 22 and the top 24 of the blade.

As represented in FIG. 2, the structural reinforcement 30 follows the form of the leading edge 16 of the aerodynamic surface 12 of blade 10 that it extends to form a leading edge 31, known as the leading edge of the reinforcement.

Conventionally, the structural reinforcement 30 is a monobloc piece comprising a section that is substantially in a V-shape presenting a base 39 forming the leading edge 31 and extended by two lateral sides 35 and 37 respectively following the lower surface 11 and the upper surface 13 of the aerodynamic surface 12 of the blade. Sides 35, 37 present a tapered or thinned profile in the direction of the trailing edge of the blade.

Base 39 comprises a rounded inner profile 33 capable of following the rounded form of the leading edge 16 of the blade 10.

The structural reinforcement 30 is metallic and preferentially is titanium-based. In fact, this material presents a high capacity to absorb energy due to shock. The reinforcement is glued to blade 10 by means of a glue known to the person skilled in the art, such as, for example, a cyanoacrylate glue or else epoxy.

This type of metal structural reinforcement 30 used for composite blade reinforcement for a turbine engine is more specifically described in particular in patent application EP1908919.

The method according to the invention enables a structural reinforcement such as that illustrated in FIG. 2 to be made, FIG. 2 illustrating the reinforcement 30 in its final state.

FIG. 3 represents a block diagram illustrating the main steps of a method 100 to produce a metal structural reinforcement 30 for the leading edge of a blade 10 such as illustrated in FIGS. 1 and 2. The first step 40 of the production method 100 is a step of cutting flat sheets. The first step 40 comprises a first sub-step 43 of cutting a first flat sheet and a second sub-step 45 of cutting a second flat sheet.

The flat sheets are cut by a cutting method known to the person skilled in the art enabling the sheets to be cut with a thin thickness, i.e., on the order of some millimeters. By way of example, the cutting method may be a laser cutting method.

The two cut sheets will enable two sides 35, 37 of the metal reinforcement 30 to be made.

The second step 42 of the production method 100 is a step of forming the cut sides 35, 37. The conformation is carried out by stressing by compression the upper face of each side 35, 37. This first forming is not permanent and enables a certain contour to be given to each side, in particular the form of a lower surface and an upper surface. The contour of the sides improves the positioning of sides 35, 37 during the next positioning step. By way of example, this compression may be carried out by a roller-burnishing or peening method. This step may also comprise an operation increasing the roughness of the inner faces of sides 35, 37 to facilitate gripping of reinforcement 30 on blade 10 but also to increase the adhesion of sides 35, 37 in the specific maintaining equipment during the next positioning step.

The third step 44 of the production method 100 is a step of positioning, or lining up, the two cut sides 35, 37. The two sides 35, 37 are positioned in specific maintaining equipment 60 so that the two sides 35, 37 have a common area in contact, or the two sides 35, 37 are separated by a defined distance by the equipment, the two sides 35, 37 forming a preform 26 of the metal reinforcement 30.

FIGS. 4 and 5 respectively represent two embodiments of this third step 44 of the production method.

More specifically, FIG. 4 represents a first embodiment in which the two sides 35, 37 are joined and present an area 36 of common contact.

Preferentially, in this embodiment, sides 35 and 37 present, at their end close to the contact area 36, a curvature obtained during the second forming step 42 enabling the contacting of sides 35, 37 to be simplified.

More specifically, FIG. 5 represents a second embodiment in which the two ends of sides 35, 37 are separated by a defined distance, the distance separating the two sides 35, 37 being determined by the equipment and in particular by the thickness and the profile 29 of an inner dagger 32 positioned between the two sides 35, 37. Preferentially, the distance separating the two ends of sides 35, 37 is less than ten millimeters.

Preferentially, in this embodiment, the sides 35 and 37 present, at their end, a curvature obtained during the second forming step 42 capable of following the profile 29 of dagger 32.

In the two embodiments, the equipment enables the two sides 35, 37 to be held in position during the next assembling step.

The shape of the equipment is made so as to form the desired contour and lower surface and upper surface profile of metal reinforcement 30.

FIG. 9 illustrates a blow-up view of the specific maintaining equipment 60 used for making the metal reinforcement for the leading edge according to the method illustrated in FIG. 3.

The specific shape equipment 60 comprises:
a stand 61,
a first left lateral vertical member 62 connected to the stand 61 by screwing means (not represented);
a second right lateral vertical member 63 connected to the stand 61 by screwing means (not represented), the stand 61 comprising oblong holes 64 so as to modify the position of the right lateral vertical member 63 by sliding along a direction parallel to the stand 61, when the screwing means are not clamped,
and possibly an inner dagger 32.

During the third positioning step 44, the two sides 35, 37 are positioned in the specific maintaining equipment 60 such that the two sides 35, 37 have a common area in contact, or the two sides 35, 37 are separated by a distance defined by the equipment 60. The right lateral vertical member 63 is positioned by sliding so as to grip the assembly formed by the sides 35, 37 and possibly the dagger 32. Once in position, the right lateral vertical member 63 is clamped in position by screwing means.

The fourth step 46 of the production method 100 is a step to construct the base 39 of the reinforcement 30 by a mass hard-surfacing with material (or filler metal), by means of an MIG (Metal Inert Gas) type arc welding process with pulsed current and pulsed deposition wire flow. The welding is carried out at the end of the two sides 35, 37, in particular at the joint area of the two sides 35, 37 referenced 28 in FIGS. 4 and 5, forming a preform 26 that is capable of receiving filler metal.

The MIG welding process enables parts of pieces to be constructed by means of high deposition rate in the form of beads with significant sections. The length and width of the hard-surfacing beads are defined by the operator according to the wire flow.

The base 39 construction step enables sides 35, 37 to be connected in position on equipment 60.

Material hard surfacing is carried out by stacking beads of a metallic material 38 (or filler metal), of large sections, on the preform 26 and more precisely at the junction of two sides 35, 37 in the area referenced 28. The number of passes, i.e., the number of material beads 38 to apply, is determined according to the desired material height as well as the width of the defined beads.

This fourth step 46 of the production method 100 is particularly represented in FIG. 6. In fact, FIG. 6 illustrates a cross sectional view of the structural reinforcement 30 being produced after the step of hard surfacing at the end of two sides 15, 17.

According to a first embodiment in which the sides 35 and 37 are joined in equipment 60, the inner profile 33 of the base 39 is approximated in a bevel by lining up the two sides 35, 37 that were previously formed during the second step 42.

According to the second embodiment in which sides 35, 37 are spaced by dagger 32 of equipment 60, the inner profile 33 of base 39 is overmolded on dagger 32. The metal produced by the hard surfacing ensures the junction between the ends of two sides 35, 37 and generates the inner profile 33 of base 39 of reinforcement 30.

The specific equipment 60 enables sides 35, 37 to be held in position during hard surfacing of material by confining the sides 35, 37.

The equipment 60 is sufficiently thick to enable dissipation of the energy produced by the MIG process such that the sides 35, 37 do not melt and are not deformed during the assembly step and/or during material hard surfacing. For that purpose, the equipment 60 is preferentially made of copper or a copper- and aluminum-based alloy.

In the second embodiment, dissipation of heat is also carried out by the central dagger 32 of equipment 60, preferentially made of copper or a copper- and aluminum-based alloy.

Dagger 32 comprises an outer profile 29 capable of preforming the inner part of each side 35, 37 of reinforcement 30 and in particular the inner extending profile 33.

The fifth step 50 of the production method 100 is a step of machining the hard surfaced area. This step 50 is illustrated in FIG. 7.

This step enables the solid portion 27 of hard surfaced material to be machined so as to approximate the shape of the final profile of the base 39 comprising the leading edge 31.

The sixth step 52 of the production method 100 is a thermal relief or relaxation step 25 of the assembly, enabling the residual stresses to be relieved. This thermal treatment step is preferentially carried out in the same specific maintaining equipment 60 that is placed in an oven at the forging temperature of the material selected.

The seventh step 54 of the production method 100 is a hot conformation step preferentially carried out in the same specific maintaining equipment 60. This hot conformation step gives reinforcement 30 its final desired shape.

According to a preferential embodiment of the invention, the sixth step 52 and seventh step 54 are carried out at the same time.

It is noted that the shape of equipment 60, and particularly the profile of dagger 32 and the profile of the right lateral vertical member 63 and of the left lateral vertical member 62 are directly connected to the desired final shape and contour of the metal reinforcement 30.

According to another embodiment, the sixth step 52 and the seventh step 54 are carried out by means of specific relief and conformation equipment capable of supporting a rise in temperature. In this case, the production method according to the invention comprises an intermediate step consisting of unclamping the assembly formed by sides 35, 37 and hard surfaced area 27 from the specific maintaining equipment 60 in order to be clamped again on the specific relief and conformation equipment.

The eighth step 56 of the production method 100 is a step of finishing and refinishing reinforcement 30 by machining. This refinishing step 56 comprises:
a first sub-step 55 of reprofiling the base 39 of reinforcement 30 so as to refine it, particularly the aerodynamic profile of the leading edge 31;
a second sub-step 57 of refinishing sides 35, 37; this step consisting in particular of contour milling the sides 35, 37 and thinning the lower surface and upper surface sides;
a third finishing sub-step 59, enabling the required surface state to be obtained.

FIG. 8 illustrates the reinforcement 30 in its final state obtained by the production method according to the invention.

In combination with these main steps of embodiment, the method according to the invention may also comprise steps for inspecting the reinforcement 30 in a non-destructive manner, ensuring the geometric and metallurgical conformity of the assembly obtained. By way of example, the non-destructive inspections may be carried out by an X-ray process.

According to a second embodiment of the invention, the first step 40 of cutting two sides, the second step 42 of forming the two sides and the third step 44 of positioning the cut sides may be replaced by a step 41 of hot forming a preform 70 in forming equipment 80.

This hot forming step 41 is illustrated in FIGS. 10 and 11. In this step, preform 70 is formed from a flat sheet 71 placed in the forming equipment 80 that is sealingly closed. Equipment 80 comprises a lower part 82 comprising a cavity 83 corresponding to the desired shape of preform 70 and an upper part 81 covering the lower part 82. In its initial state, flat sheet 71 is held clamped at its ends between the two parts 81, 82 of equipment 80. The hot forming step consists of using the property of metals that can be deformed without breaking at a given temperature, such as for example aluminum or else titanium. By way of example, titanium under certain temperature conditions, for example at 940° C., has an elongation rate of greater than 35%.

By way of example, a hot forming method used for this step may be a superplastic forming (SPF) method.

Superplastic forming is a method enabling complex pieces to be produced in sheets with thin thicknesses and in a single operation.

For implementing this method, sheet 71 is heated to a given temperature, for example to a temperature equivalent to half of the melting point of the material. At this temperature, sheet 71 is deformed by the pressure of a neutral gas, for example argon, introduced inside the closed equipment 80. The evolution of this gas pressure, represented by arrows in FIG. 11, is controlled such that the forming of sheet 71 is carried out in the superplastic domain that is associated with a deformation rate range specific to each material family. In a known manner, predicting the evolution law of the forming pressure is carried out by digital simulation so as to optimize the forming and the cycle time of such a method.

When the preform 70 is formed, it comprises, similar to the previous embodiment, sides 35, 37 interconnected by an end 72 capable of receiving the filler metal. Preform 70 is then removed from equipment 80 so as to undergo an operation increasing the roughness of the inner faces of sides 35, 37 in view of increasing the adhesion of preform 70 in the equipment 60 during the material hard surfacing step and facilitating the gripping of reinforcement 30 on blade 10.

After unmolding and increasing the roughness of the inner faces of sides 35, 37, the fourth step 46 of constructing the base 39 of the reinforcement 30 enables a mass hard-surfacing with material (or filler metal), by means of an MIG (Metal Inert Gas) type arc welding process with pulsed current and pulsed deposition wire flow.

Hard surfacing of material is carried out at end 72 of preform 70.

As described previously, the MIG welding process enables parts of pieces to be constructed thanks to a high deposition rate in the form of beads with significant sections. The length and width of the hard-surfacing beads are defined by the operator according to the wire flow.

The method according to the invention was described mainly for a titanium-based metal structural reinforcement; However, the method according to the invention is also applicable to nickel-based or else steel-based materials.

The use of an MIG type welding process obtains, with a welding process, the structural and mechanical characteristics of a material obtained by casting or forging. In fact, the welded joint obtained by the MIG process comprises the same mechanical characteristics as the wrought material.

The invention was particularly described with an MIG type welding process, however, the MIG welding process may be replaced by another type of material hard surfacing process such as a powder surfacing process (of the Laser Cladding type), obtaining characteristics close to a wrought material.

The invention was particularly described for producing a metal reinforcement for a composite turbine engine blade; however, the invention is also applicable for producing a metal reinforcement for a metal turbine engine blade.

The invention was particularly described for producing a metal reinforcement for a leading edge of a turbine engine blade; however, the invention is also applicable for producing a metal reinforcement of a trailing edge of a turbine engine blade.

Other advantages of the invention are, in particular, as follows:
reduced production costs;
reduced production time;
simplified manufacturing process;
reduced material costs.

FIGS. 12 to 21 describe a second method to produce a metal reinforcement for a leading edge, or trailing edge, of a turbine engine blade comprising, in sequence:
a step of positioning a first metal sheet and a second metal sheet on a section by means of specific equipment positioning said section and said metal sheets such that each metal sheet presents a contact surface positioned parallel with a contact surface of said section;
a step of welding without filler metal said metal sheets on said section such that said contact surface of said first metal sheet is connected with said contact surface of said section and such that said contact surface of said second metal sheet is connected with said contact surface of said section.

Thanks to this second method, the metal structural reinforcement is produced simply and rapidly from two flat metal sheets, a standard commercial section and a welding process without the use of filler metal.

This production method therefore eliminates the complex production of the reinforcement by milling in the mass from monobloc flat parts requiring large volumes of stock material and, consequently, significant costs to supply the raw material.

In fact, the cost of obtaining a metal reinforcement for a leading edge or trailing edge of a turbine engine blade is particularly reduced especially by the reduction in the volume of material necessary for making the reinforcement, by the standard commercial supply (bars, sheets) and by the use of industrial methods that are inexpensive to implement.

Welding without the use of a filler metal obtains a welding area comprising identical mechanical characteristics to the wrought or forged material with a very short welding cycle time.

According to an advantageous embodiment, the two metal sheets are welded simultaneously on the section. The simultaneous welding of two metal sheets on the section facilitates, in particular, the metal sheet maintaining process and obtains the same removal of material for each of the sheets, the removal of material resulting from the formation of welding beads.

The second method to produce a metal reinforcement for a turbine engine blade may also present one or more of the characteristics below, considered individually or according to all technically possible combinations:

said metal sheets are welded simultaneously on said section;
said step of welding said metal sheets on said section is carried out by means of a linear friction welding process;
said step of welding said metal sheets on said section is carried out by means of a resistance welding process or by a flash welding process;
said positioning step is preceded by a step of forming and/or bending the section and/or said metal sheets;
said welding step is followed by a shaving step by machining the welding beads and/or extending said section so as to form the inner profile of said metal reinforcement;
the method comprises a hot conformation step in hot conformation equipment comprising a central dagger capable of conforming the profile of said metal sheets, said dagger extending beyond the welding joints, formed during said welding step, so as to prevent the deformation of said welding joints during said hot conformation step;
the method comprises a thermal treatment step to relieve stresses;
the method comprises a finishing step of said metal reinforcement consisting of:
a sub-step of mechanical refinishing by milling said section so as to obtain the aerodynamic profile of the leading edge, or trailing edge, and the base of the reinforcement;
a sub-step of cutting said metal sheets so as to obtain the sides of the reinforcement;
a sub-step of polishing the surface of said metal sheets;
the method comprises a step of cutting said first metal sheet and said second metal sheet by a cutting and/or machining method of said section by a milling or rolling method.

The second production method also enables a structural reinforcement such as that illustrated in FIG. 2 to be made, FIG. 2 illustrating the reinforcement 30 in its final state.

FIG. 12 represents a block diagram illustrating the main steps of the second production method 200 of a metal structural reinforcement 30 for the leading edge of a blade 10 such as illustrated in FIGS. 1 and 2.

The first step 110 of the production method 200 is illustrated in FIG. 13 and corresponds to a step of cutting the flat sheets 141, 142 and machining a section 144.

The flat sheets 141, 142 are cut from standard commercial sheets along a specific profile 143 corresponding to a profile approximating the longitudinal shape of the leading edge 16 of blade 10.

The flat sheets 141, 142 are cut by a cutting method known to the person skilled in the art enabling the sheets to be cut with a thin thickness, i.e. on the order of some millimeters. By way of example, the cutting method may be a laser cutting method or a waterjet cutting or piercing method.

The two cut sheets 141, 142 are intended to form two lower surface and upper surface sides 35, 37 of the metal reinforcement 30 illustrated in FIG. 2.

Section 144 is conventionally produced for example by a rolling or milling method from a standard bar of material. Section 144 may also be produced by extrusion and milling of a standard section. Section 144 is a preform enabling the base 39 of the reinforcement 30 illustrated in FIG. 2 to be formed.

The machined section 144 is a rectilinear section with a prismatic shape whose upper face 145 comprises a longitudinal groove 148 and a first part 146 and a second part 147 projecting on both sides of groove 148.

The second step 120 of the production method 200 is a step of forming and/or bending the section 144 and possibly the cut sheets 141, 142. The bending is carried out by stressing the section 144 and/or sheets 141, 142, for example by means of a press.

The bent section 144 and cut sheets 141, 142 are illustrated in FIG. 14. It will be noted that the bending of section 144 is determined so as to follow the specific profile 143 of cut sheets 141, 142 and so as to obtain substantially the definitive shape of the leading edge 16 of blade 10.

According to a first embodiment of the second production method, bending of section 144, and possibly sheets 141, 142 is carried out along two dimensions. However, it is also possible to carry out bending of section 144 directly in three dimensions as well as sheets 141, 142.

The third step 130 of the production method 200 is a step of positioning, or lining up, the two cut sheets 141, 142 on section 144. This step in particular enables the positioning of the contact surface 149 of each cut sheet 141, 142 on the upper surface of each part 146, 147 of section 144.

For that purpose, the two sheets 141, 142 and the section 144 are positioned in specific equipment 160 capable of maintaining the assembly, particularly during the following welding step. This third step 130 is illustrated in FIG. 15a and FIG. 15b. More particularly, FIG. 15a illustrates a side view of the positioning of two cut sheets 141, 142 on section 144 and FIG. 15b illustrates more particularly a section of FIG. 15a along a cutting plane C-C illustrated in FIG. 15a.

The two cut sheets 141, 142 are respectively positioned facing a projecting part 146, 147 of section 144.

FIG. 21 illustrates a cross sectional view of an example of maintaining equipment 160 maintaining the cut sheets 141, 142 and section 144 in position.

The specific maintaining equipment 160 comprises:
an upper cassette 171 comprising an upper insert 172;
a lower cassette 161 comprising a lower insert 162.

The lower insert 162 comprises a recess 169 capable of receiving the section 144. Section 144 is clamped in position in the lower insert 162 by means of screwing means 163 on the entire length of section 144. For this purpose, section 144 is sized so as to present sufficient material for clamping in the lower insert 162.

The cut sheets 141, 142 are maintained in position in the upper insert 172 of equipment 160. For that purpose, the upper insert 172 is formed by an upper base 173 comprising a central element 175 with a prismatic shape projecting with relation to the joint plane 170 of the upper base 173 and the lower base 174. The lower base 174 is formed by two parts 174a and 174b that pin sheets 141, 142 in position against the lateral walls of the central element 175 during clamping of the upper base 173 and lower base 174. Clamping of the assembly is carried out by screwing means 176.

The fourth step 140 of the production method 200 is a step of welding sheets 141, 142 on section 144 without adding filler metal. According to a first embodiment, the welding process is a linear friction welding process. Linear friction welding is carried out by means of the specific maintaining equipment 160 that is assembled on a vibrating table (not represented).

Friction welding is a mechanical welding process where the heat necessary for the welding is provided by friction, or rotation in the case of an orbital friction welding process, of a first piece against a second piece, the two pieces to be assembled being subjected to opposing axial pressure.

Friction is carried out by the oscillation of a piece while the other piece is held fixed. According to an advantageous embodiment, the lower insert 162 clamping section 144 is held fixed while the upper insert 172 clamping sheets 141, 142 oscillates according to a direction parallel to the joint plane 170.

When the two sheets 141, 142 enter simultaneously in contact, at their contact surface 149, with projecting parts 146, 147 of section 144, by the upper cassette 171 and lower cassette 161 gradually moving together, the friction forces bring about a resist torque. The mechanical energy created is transformed into heat in the contact surface, rapidly increasing the temperature up to the welding temperature (forging temperature of the materials used).

During the heating and welding phase, a quantity of material is pushed towards the outside, thus forming welding beads 151 as well as shortening of the pieces in movement. This step is illustrated in FIG. 16. More particularly, FIG. 16 illustrates a view of two sheets 141, 142 welded by linear friction on section 144.

Equipment 160 enables the two sheets 141, 142 to be linear friction welded simultaneously on section 144 while positioning the friction surfaces of sheets 141, 142 and section 144 in parallel. That is to say that during the linear friction welding step, each contact surface 149 of the two metal sheets 141, 142 is parallel to a contact surface of parts 146, 147 of section 144.

The simultaneous welding of two sheets 141, 142 facilitates, in particular, the metal sheet 141, 142 maintaining process and obtains the same removal of material for each of the sheets 141, 142, the removal of material resulting from the formation of welding beads 151.

According to the embodiment illustrated in FIG. 21, the two metal sheets 141, 142 are V-welded on section 144. According to a second embodiment that is not represented, the two metal sheets 141, 142 may be welded in parallel on section 144.

Linear friction welding obtains identical mechanical characteristics to wrought or forged material with a very short welding cycle time.

The fifth step 150 is a welding bead 151 shaving step by machining and extending groove 148 so as to form the inner profile 33 of the final metal reinforcement 30. This fifth step is illustrated in FIG. 17. The inner profile 33 corresponds to the profile of the metal reinforcement 30 in its final state and is defined so as to optimize the distribution of stresses in the reinforcement.

The sixth step 160 is a hot conformation step giving the final form to reinforcement 30. This hot conformation step is carried out in specific equipment 180 capable of withstanding a temperature rise in an oven to the forging temperature of the material used.

Equipment 180, as illustrated in FIG. 18, is formed by an upper part 181 and a lower part 182 bordering both sides of metal sheets 141, 142 welded to the section 144 and conformed forming the reinforcement 30. Equipment 180 also comprises a central dagger 183 capable of being inserted between the two sheets 141, 142. The shape of equipment 180 and more particularly the shape of the upper 181 and lower 182 parts and the profile of the dagger 183 correspond to the final lower surface and upper surface profiles of sides 35, 37 of the metal reinforcement 30.

The upper 181 and lower 182 parts of equipment 180 comprise, at their inner face, a recess capable of receiving and maintaining the section 144 in position during the hot conformation step.

It will be noted that dagger 183 is sized so that the welding joints between sheets 141, 142 and section 144, formed during welding step 140, are supported on dagger 183. In this way, the stresses and deformations are limited in these welding areas during hot conformation. Advantageously, dagger 183 is inserted between two sheets 141, 142 so as to follow to the maximum the inner profile of section 144. For this purpose, the dagger 183 is adapted as a function of the defined inner profile 33 and comprises a shape that is complementary to the inner profile 33.

During the conformation step, the specific equipment 180 is placed in an oven at the forging temperature of the material used. This thermal treatment also relaxes the residual stresses of the assembly.

The seventh step 170 is a finishing and mechanical refinishing step illustrated in FIG. 19. This step comprises a first mechanical refinishing sub-step by milling section 144 so as to produce the aerodynamic profile of the leading edge 31 as well as the base 39 of reinforcement 30 illustrated in FIGS. 2 and 20. A second sub-step consists of the cutting and contour milling of welded sheets 141, 142 and forming so as to obtain sides 35, 37 of the final reinforcement 30. This sixth step 160 also comprises a sub-step of polishing sheets 141, 142 so as to obtain the required surface state and desired thickness of sides 35, 37, particularly at the thin parts intended to envelop the composite material of blade 10.

FIG. 20 illustrates in side view reinforcement 30 in its final state obtained by the second method to make a metal reinforcement.

In combination with these main steps of embodiment, the second method may also comprise steps for inspecting the reinforcement 30 in a non-destructive manner, ensuring the geometric and metallurgical conformity of the assembly obtained. By way of example, the non-destructive inspections may be carried out by an X-ray process.

According to a second embodiment of the second production method, the fourth step 140 of welding sheets 141, 142 on section 144 is carried out by a flash welding or else resistance welding process. Flash welding and resistance welding are two processes that do not require filler metal to weld pieces.

Flash welding and resistance welding use the Joule effect due to the passage of a low voltage and high intensity current to melt and weld pieces.

In the flash welding process, the passage of intense current through irregularities distributed on the contact faces between the two pieces produces arcs with ejections and vaporizations of melted metal toward the outside of the contact faces. From the end of the flash, a displacement effort is applied to the pieces to be assembled repelling in seam form the thin layer of liquid that remains on the contact surface.

In the resistance welding process, the pieces to be assembled are tightened in jaws that ensure the current supply. The faces to be assembled must be carefully prepared and free of oxides and scale. Once current passes through, the pieces heat up and join by the Joule effect. Significant effort is exerted for the welding operation so that the metal is displaced. Metal in the plastic state forms a bead on both sides of the joint section.

Flash and resistance welding obtains identical mechanical characteristics to wrought or forged material with a very short welding cycle time.

According to an advantageous embodiment of the second production method, the two sheets 141, 142 are simultaneously welded on section 144.

The second production method was described mainly for a titanium-based metal structural reinforcement; however, the second production method is also applicable to nickel-based or else steel-based materials.

The second production method was particularly described for producing a metal reinforcement for a composite turbine engine blade; however, the second production method is also applicable for producing a metal reinforcement for a metal turbine engine blade.

The second production method was particularly described for producing a metal reinforcement for a leading edge of a turbine engine blade; however, the second production method is also applicable for producing a metal reinforcement for a trailing edge of a turbine engine blade.

Other advantages of the second production method are, in particular, as follows:
reduced production costs;
reduced production time;
simplified manufacturing process;
reduced material costs;
high metallurgical quality of the welded area.

1. A method to produce a metal reinforcement for a leading edge or a trailing edge of a turbine engine blade, the method comprising:
positioning a preform using an equipment that positions said preform in a position such that said preform presents, at one end, an area which is capable of receiving a filler metal;
subsequent to said positioning, constructing a base for said metal reinforcement by hard-surfacing with filler metal in said area, in the form of metal beads.

2. The method to produce a metal reinforcement for a turbine engine blade according to claim 1, wherein said constructing is carried out using an MIG welding apparatus comprising a pulsed current generator and presenting a pulsed deposition wire flow.

3. The method to produce a metal reinforcement for a turbine engine blade according to claim 1, wherein said preform comprises a first metal sheet and a second metal sheet positioned, using said equipment, in a non-parallel position such that the first metal sheet and the second metal sheet present at their end an area capable of receiving said filler metal, said constructing connecting said metal sheets in position.

4. The method to produce a metal reinforcement for a turbine engine blade according to claim 1, wherein said preform is formed by a hot preformed metal sheet such that said preform comprises sides and at said one end the area capable of receiving said filler metal.

5. The method to produce a metal reinforcement for a turbine engine blade according to claim 1, wherein said constructing is followed by machining said hard surfaced material in said end area so as to approximate a final profile of said base.

6. The method to produce a metal reinforcement for a turbine engine blade according to claim 5, comprising performing a thermal treatment step to relax stresses.

7. The method to produce a metal reinforcement for a turbine engine blade according to claim 5, comprising performing a hot conformation step.

8. The method to produce a metal reinforcement for a turbine engine blade according to claim 6, comprising finishing said metal reinforcement, said finishing including refinishing said hard surfaced material so as to refine the final profile of said base and the leading edge or trailing edge of said metal reinforcement and/or refinishing of metal sheets so as to form the sides of said metal reinforcement.

9. The method to produce a metal reinforcement for a turbine engine blade according to claim 3, comprising cutting said first metal sheet and said second metal sheet by laser cutting.

10. The method to produce a metal reinforcement for a turbine engine blade according to claim 4, comprising increasing a roughness of the inner faces of said sides.

11. The method to produce a metal reinforcement for a turbine engine blade according to claim 3, comprising forming said metal sheets before said positioning.

12. The method to produce a metal reinforcement for a turbine engine blade according to claim 3, wherein, during said positioning, said metal sheets are formed in said equipment and are maintained joined.

13. The method to produce a metal reinforcement for a turbine engine blade according to claim 3, wherein, during said positioning, said metal sheets are formed and maintained spaced by a dagger positioned between said metal sheets, an outer profile of said dagger conforming a lower surface and upper surface profile of said metal sheets.

14. The method to produce a metal reinforcement for a turbine engine blade according to claim 3, comprising evacuating heat from said metal sheets in position in said equipment via said equipment.
